(19) United States
(12) Patent Application Publication
(10) Pub. No.: US 2021/0234672 A1
(43) Pub. Date: Jul. 29, 2021

(54) METHOD AND SYSTEM FOR TRACING FULL-LIFE-CYCLE QUALITY OF PREFABRICATED PART BASED ON BLOCKCHAIN

(71) Applicant: CHINA STATE CONSTRUCTION ENGINEERING CORPORATION LIMITED, BEIJING (CN)

(72) Inventors: TAO ZENG, BEIJING (CN); HAISHAN GUO, BEIJING (CN); KANG LIU, BEIJING (CN); YUZHONG CAO, BEIJING (CN); XIAOJIE YANG, BEIJING (CN); HU QI, BEIJING (CN); LIMING LI, BEIJING (CN)

(21) Appl. No.: 17/050,963

(22) PCT Filed: Apr. 16, 2019
(86) PCT No.: PCT/CN2019/082828

§ 371 Date: Oct. 27, 2020

(30) Foreign Application Priority Data
Apr. 27, 2018 (CN) 201810395348.3

(51) Int. Cl. H04L 9/06; G06K 7/14; H04W 4/80

(52) U.S. Cl. CPC H04L 9/0643; H04L 2209/38; H04W 4/80; G06K 7/1434

(57) ABSTRACT

The present disclosure discloses a method and system for tracing a full-life-cycle quality of a prefabricated part based on a blockchain, wherein the method includes: step S1: establishing a prefabricated-part-quality tracing standard in which tracing information is able to be intercommunicated; step S2: gathering and storing tracing information of quality events of the prefabricated part at nodes during a full life cycle; step S3: performing blockchain distributed bookkeeping to the tracing information of the quality events of the prefabricated part at the nodes during the full life cycle; and step S4: realizing quality tracing of the prefabricated part at the nodes during the full life cycle based on a uniform tracing interface and a safe access policy. The present disclosure can effectively solve the problems in the standard, efficiency, reliance, safety and supervision of the quality tracing of prefabricated parts in the industrialization of novel constructions.

### CROSS REFERENCE TO RELATED APPLICATIONS

This application is a continuation of International Patent Application No. PCT/CN2019/082828 with a filing date of Apr. 16, 2019, designating the United States, now pending, and further claims priority to Chinese Patent Application No. 201810395348.3, filed on Apr. 27 2018, the entire content of which is incorporated herein by reference.

### TECHNICAL FIELD

The present disclosure relates to the field of quality tracing in the industrialization of novel constructions, and particularly relates to a method and system for tracing a full-life-cycle quality of a prefabricated part based on a blockchain.

### BACKGROUND

Currently, the quality tracing of prefabricated parts in the field of constructions has the following problems: (1) lack of a uniform standard of quality tracing; (2) lack of the matching with international standards; (3) lack of the high-efficiency gathering, storing and falsification prevention of quality information at the nodes; (4) lack of an entrusting mechanism of quality information at the nodes; and (5) lack of a method for full-chain quality tracing of the supply chain in the process of constructing and full-life-cycle quality tracing in the process of constructing. Therefore, a method of the full-chain tracing and globalized tracing in the process of constructing and the full-life-cycle tracing of constructions of the quality of prefabricated parts is urgently needed.

### SUMMARY

The present disclosure seeks to solve the technical problem of realizing the full-chain tracing in the process of constructing and the full-life-cycle tracing of constructions of the quality of prefabricated parts in the industrialization of novel constructions.

In order to solve the above technical problem, the present disclosure provides a method and system for tracing a full-life-cycle quality of a prefabricated part based on a blockchain.

According to an aspect of the present disclosure, there is provided a method for tracing a full-life-cycle quality of a prefabricated part based on a blockchain, wherein the method comprises the steps of:

step S1: establishing a prefabricated-part-quality tracing standard in which tracing information is able to be intercommunicated;

step S2: gathering and storing tracing information of quality events of the prefabricated part at nodes during a full life cycle;

step S3: performing blockchain distributed bookkeeping to the tracing information of the quality events of the prefabricated part at the nodes during the full life cycle; and

step S4: realizing quality tracing of the prefabricated part at the nodes during the full life cycle based on a uniform tracing interface and a safe access policy.

Optionally, the nodes of the prefabricated part during the full life cycle include one or more nodes selected from designing, production, transportation, construction, operation, maintenance and supervision.

Optionally, the step S1 comprises:

encoding unifiedly prefabricated parts;

identifying unifiedly the prefabricated parts by using RFID/barcode gathering devices;

identifying unifiedly the information of the RFID/barcode gathering devices and the information of related operators;

encoding and describing unifiedly quality events of the prefabricated parts at the nodes; and

defining tracing interfaces and access protocols of the quality events of the prefabricated parts at the nodes.

Optionally, the step S2 comprises:

gathering by using a gathering unit the tracing information of the quality events of the prefabricated part at the nodes during the full life cycle; and

by using a storing and screening unit, storing quality-event business information of the nodes in business systems of the nodes, screening critical quality tracing information, and keeping the critical quality tracing information into a blockchain distributed ledger, to realize light weighting of chain uploading of the quality tracing information.

Optionally, the quality tracing method further comprises: before the step S3, importing a BIM model of the prefabricated part at the nodes during the full life cycle into a quality tracing system, and simultaneously uploading a generated hash value of the BIM model to the blockchain distributed ledger.

Optionally, the prefabricated parts include but are not limited to a prefabricated concrete part, a prefabricated steel part and a prefabricated wood part.

Optionally, the step S3 comprises:

step S301: establishing and initializing a blockchain, authorizing read-write access permission to the blockchain, analyzing operation data and operation characteristics of an authorized party, and if an abnormal behavior happens, revoking the permission;

step S302: keeping an ID, critical tracing information, a digital signature and a timestamp of the quality event into the blockchain distributed ledger; and

step S303: performing, by a supervising party, casual inspection to the quality event to obtain supervision-result information, and keeping the ID, the supervision-result information, the digital signature and the timestamp of the quality event into the blockchain;

wherein the blockchain comprises one source-blockchain address and a plurality of destination-blockchain addresses, and the quality event is transmitted from the source-blockchain address to the destination-blockchain addresses via a proprietary network.

Optionally, the step S4 comprises:

by using the uniform tracing interface of the quality events of the nodes, further accessing particular information of the quality events; and

based on the safe access policy, feeding back open information and private information to inquiring parties having different permissions according to different permission settings.

According to another aspect of the present disclosure, there is provided a system for tracing a full-life-cycle quality of a prefabricated part based on a blockchain, wherein the system comprises:

a unified-tracing-standard module configured to establish a prefabricated-part-quality tracing standard in which tracing information is able to be intercommunicated;

a tracing-information Internet-of-Things gathering module configured to gather and store tracing information of quality events of the prefabricated part at nodes during a full life cycle;

a tracing-information blockchain bookkeeping module configured to perform blockchain distributed bookkeeping to the tracing information of the quality events of the prefabricated part at the nodes during the full life cycle; and

a unifiedly inquiring and tracing module configured to realize quality tracing of the prefabricated part at the nodes during the full life cycle based on a uniform tracing interface and a safe access policy.

Optionally, the system for tracing a full-life-cycle quality of a prefabricated part based on a blockchain further comprises:

a quality tracing BIM module configured to import a BIM model of the prefabricated part at the nodes during the full life cycle into the quality tracing system, and simultaneously upload a generated hash value of the BIM model to the blockchain distributed ledger.

Optionally, the tracing-information blockchain bookkeeping module is further configured to, based on a multilayer convolutional neural network, perform classification, characteristic extraction, action judgement and authorization controlling to the quality-event tracing information.

As compared with the prior art, one or more embodiments of the above solutions can have the following advantages or advantageous effects:

(1) The present disclosure can effectively solve the problems in the standard, efficiency, reliance, safety and supervision of the quality tracing in the industrialization of novel constructions.

(2) The present disclosure can support the tracing of quality-event information of prefabricated parts in full supply chain, all over the world and during full life cycle.

(3) The present disclosure can realize efficient and safe gathering and recording of the tracing information of the quality events at the critical nodes such as designing, production, transportation, construction, operation, maintenance and supervision.

(4) The present disclosure can realize the distributed bookkeeping of the tracing information of the quality events at the critical nodes such as designing, production, transportation, construction, operation, maintenance and supervision, to realize the decentralization, undeletableness and unchangeableness of the storage of the quality-event tracing information at the critical nodes.

(5) The present disclosure can, by using the unifiedly inquiring and tracing module, by using the quality-event distributed ledger, realize inquiring and quality tracing based on the safety policy by the quality related parties of the nodes.

(6) The present disclosure can realize the association of the prefabricated part with the designing information, the spatial position information of the construction and the logical relation between the systems of the construction.

(7) The present disclosure can realize the association and tracing of prefabricated parts with the quality-event information in the process of operation and maintenance and the process of constructing (designing, production, transportation, construction, operation, maintenance and supervision).

(8) The method and system according to the present disclosure can improve the transparency and the management quality of the entire supply chain of prefabricated parts, and improve the level of management during full life cycle of constructions. Moreover, they help the construction industry of China enter the global market, to practice the “One Belt and One Road” strategy of the country.

(9) The method and system according to the present disclosure can realize the communication between the blockchains of different enterprises.

The other characteristics and advantages of the present disclosure will be described in the subsequent description, and part of the advantages can become apparent from the description or be understood by the implementation of the present disclosure. The objects and the other advantages of the present disclosure can be realized and obtained from the structures particularly illustrated in the description, the claims and the drawings.

### BRIEF DESCRIPTION OF THE DRAWINGS

The drawings are intended to provide a further understanding of the present disclosure, and constitute part of the description. The drawings are intended to interpret the present disclosure along with the embodiments of the present disclosure, and do not function to limit the present disclosure. In the drawings:

FIG. 1 shows a flow chart of the first embodiment of the present disclosure;

FIG. 2 shows a system diagram of the first embodiment of the present disclosure;

FIG. 3 shows a flow chart of the second embodiment of the present disclosure; and

FIG. 4 shows a system diagram of the second embodiment of the present disclosure.

### DETAILED DESCRIPTION

The embodiments of the present disclosure will be described in detail below with reference to the drawings, whereby the implementation process in which the present disclosure applies the technical means to solve the technical problems achieve the technical effects can be sufficiently understood and accordingly implemented. It should be noted that, subject to the avoiding of any conflict, the embodiments and the features of the embodiments of the present disclosure can be combined, and the technical solutions that are obtained fall within the protection scope of the present disclosure.

### The First Embodiment

In order to solve the problem in the prior art that, in the field of the industrialization of constructions, the full-chain tracing in the process of constructing of the quality information of prefabricated parts cannot be realized, the first embodiment of the present disclosure provides a method and system for tracing a full-life-cycle quality of a prefabricated part based on a blockchain.

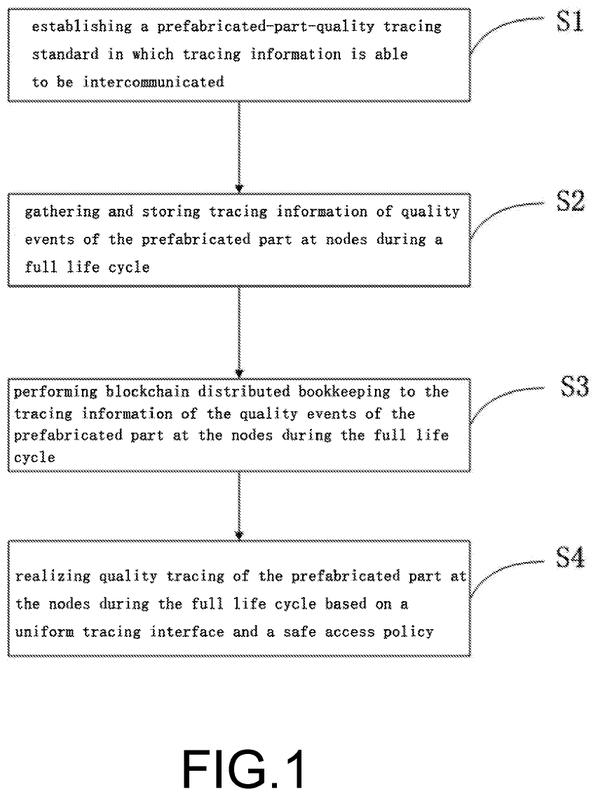

As shown in FIG. 1, FIG. 1 is a flow chart of the first embodiment of the present disclosure. The method according to the embodiment of the present disclosure comprises the steps of:

step S1: establishing a prefabricated-part-quality tracing standard in which tracing information is able to be intercommunicated;

step S2: efficiently and safely gathering and storing tracing information of quality events of the prefabricated part at nodes during a full life cycle;

step S3: performing blockchain distributed bookkeeping to the tracing information of the quality events of the prefabricated part at the nodes during the full life cycle; and

step S4: realizing quality tracing of the prefabricated part at the nodes during the full life cycle based on a uniform tracing interface and a safe access policy.

In the present embodiment, the step S1 comprises:

step S101: encoding unifiedly prefabricated parts. This step integrates the relevant international norms for quality tracing, and the current standards in China of classification of prefabricated construction parts and so on, to systematically form an unifiedly encoding regulation of prefabricated parts that is open-ended, extendable, suitable for the situation of a country and compatible with the international norms, including but not limited to the following example:

| | | | | | |
|---|---|---|---|---|---|
| | | | project- | prefabricated-part | |
| encoding | version | project | site | classification | serial |
| type | number | encoding | encoding | encoding | number |

| | | | |
|---|---|---|---|
| BIM-model | variable field | blockchain | length |
| two-dimensional | | address | |
| code | | | |

The BIM-model two-dimensional code is used to download a BIM light-weighting model, the variable field is reserved as standby information, and the length is used to record the total length of the encoding.

step S102: identifying unifiedly the prefabricated parts by using RFIDs or barcodes.

The RFID/barcode gathering devices are the related operators (such as fingerprints and irises) are unifiedly identified.

step S103: encoding and describing unifiedly quality events of the prefabricated parts at the nodes. Unified encoding regulations of quality events are systematically formed, including but not limited to the following example:

| | | | | | |
|---|---|---|---|---|---|
| version | critical | | operation | tracing | |
| number | tracing point | event type | type | information | note |

| | | |
|---|---|---|
| BIM-model | source-blockchain | destination-blockchain |
| two-dimensional code | address | address |

The BIM-model two-dimensional code is used to download a BIM light-weighting model, the variable field is reserved as standby information, and the length is used to record the total length of the encoding. The source-blockchain address represents the address of the blockchain where the current quality event happens, and the destination-blockchain address represents the address of the blockchain that the current information is required to be transmitted to. The quality event is transmitted from the source-blockchain address to the destination-blockchain addresses via a proprietary network, and firstly enters the information queue of the destination-blockchain addresses, and the pieces of information in the information queue are transmitted to the destination blockchains in a sequence in which the information coming earlier is processed earlier.

step S104: defining tracing interfaces and access protocols of the quality events of the prefabricated parts at the nodes.

Particularly, intra-blockchain and inter-blockchain tracing interfaces of the above quality events are defined, and are used to, based on the different safe access policies, feed back open information and private information to inquiring parties according to different permission settings of the inquiring parties.

In the present embodiment, the step S2 comprises:

step S201: by using a gathering unit (gathering by using a fixed device/gathering by using a hand-held device), efficiently gathering the tracing information of the quality events of the prefabricated part at nodes such as designing, production, transportation, construction, operation, maintenance and supervision; and

step S202: by using a storing and screening unit, storing quality-event business information of the nodes in business systems of the nodes, screening critical quality tracing information, and keeping the critical quality tracing information into a blockchain distributed ledger.

The quality-event business information includes a quality event ID, tracing-interface information and safety-policy information. The critical quality tracing information includes authenticated-device information, operator information (such as fingerprints and irises), encrypted information and so on.

The encrypting modes of the encrypted information include but are not limited to random encryption as in the present embodiment, and the key is generated randomly, encrypted by using MD5, and added the tracing information.

In the present embodiment, the step S3 particularly comprises, by using the blockchain bookkeeping module 3, performing blockchain distributed bookkeeping to the tracing information of the quality events of the nodes, to realize the decentralization, undeletableness and unchangeableness of the storage of the quality-event tracing information at the critical nodes. The type of the blockchain is between public blockchain and private blockchain, which can effectively improve the consensus efficiency and the expansibility of the nodes. Moreover, the step comprises performing classification and feature extraction to the quality tracing data of the authorized enterprises and the authorized reading devices based on the multilayer convolutional neural network, to perform action judgement and authorization controlling. The step particularly comprises:

step S301: establishing and initializing a blockchain, authorizing read-write access permission to the blockchain, analyzing operation data and operation characteristics of an authorized party, and if an abnormal behavior happens, revoking the permission.

Particularly, the type of the blockchain employed in this step is between public blockchain and private blockchain, which can effectively improve the consensus efficiency and the expansibility of the nodes. A core enterprise (the authorizing party) establishes and initializes the blockchain. The enterprise may authorize the read-write access permission on the blockchain to other enterprises (the authorized parties), and analyze the operation data and the operation characteristics of the authorized enterprise (the authorized parties) every day. If an abnormal behavior happens, the core enterprise (the authorizing party) can revoke the permission at any time.

Particularly, the authenticated devices of the authorized enterprises (the authorized parties) can write quality-event tracing information into the blockchain. The predominant enterprise (the authorizing party) issues certificates to the authenticated devices, and analyzes the operation data and the operation characteristics of the authenticated devices every day. If an abnormal behavior happens, the predominant enterprise (the authorizing party) can revoke the certificate of authority at any time.

The authenticated device operates a closed operating system, wherein the operating system is a quality tracing system. If it is detected that another process is running, the system writes abnormal information into the blockchain. The predominant enterprise (the authorizes party), after obtaining the abnormal information by inquiring the blockchain, can revoke the certificate of authority at any time. The information of each of the authenticated devices can be inquired in the blockchain.

step S302: keeping an ID, critical tracing information, a digital signature and a timestamp of the quality event into the blockchain distributed ledger.

Particularly, when an authorized node generates a quality event, the ID, the critical tracing information, the digital signature and the timestamp of the quality event are kept into the blockchain distributed ledger; and when an authorized node and an associated authorized node generate quality events, the IDs, the critical tracing information, the digital signatures of both parties and the timestamps of the quality events are kept into the blockchain distributed ledger.

step S303: performing, by a supervising party, casual inspection to the quality event to obtain supervision-result information, and keeping the ID, the supervision-result information, the digital signature and the timestamp of the quality event into the blockchain.

Particularly, when the authorized business nodes (designing, production, transportation, constructing, operation and maintenance) generate a quality event, a pair of public key and private key of quality event is simultaneously generated. The public key can be disclosed to all of the nodes, and the private key is not disclosed. The supervising party, by using the private key, reads the quality event of the relevant authorized business node, performs casual inspection to it, and keeps the ID, the supervision-result information, the digital signature and the timestamp of the quality event into the blockchain distributed ledger, thereby completing the loop-locked blockchain distributed bookkeeping of all the participating parts in the quality tracing (the information of the business parties and the information of the supervising party).

In the present embodiment, the step S4 comprises:

by using the uniform tracing interface of the quality events of the nodes, further accessing the particular information of the quality events stored in the business systems of the nodes; and

based on the safe access policy, feeding back open information and private information to inquiring parties having different permissions according to different permission settings.

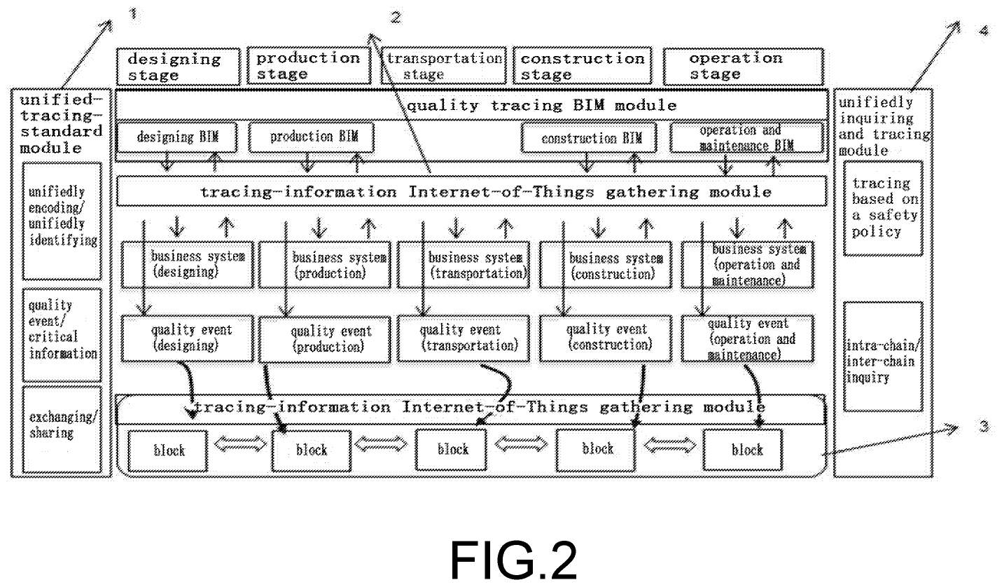

As shown in FIG. 2, FIG. 2 is a system diagram of the first embodiment of the present disclosure. The system for tracing a full-life-cycle quality of a prefabricated part based on a blockchain according to the first embodiment of the present disclosure comprises:

a unified-tracing-standard module 1 configured to establish a prefabricated-part-quality tracing standard in which tracing information is able to be intercommunicated;

a tracing-information Internet-of-Things gathering module 2 configured to gather and store tracing information of quality events of the prefabricated part at nodes during a full life cycle;

a tracing-information blockchain bookkeeping module 3 configured to perform blockchain distributed bookkeeping to the tracing information of the quality events of the prefabricated part at the nodes during the full life cycle; and

a unifiedly inquiring and tracing module 4 configured to realize quality tracing of the prefabricated part at the nodes during the full life cycle based on a uniform tracing interface and a safe access policy.

wherein the tracing-information Internet-of-Things gathering module 2 comprises a gathering unit and a storing and screening unit.

The gathering unit 201 (gathering by using a fixed device/gathering by using a hand-held device) is configured to efficiently gather the tracing information of the quality events of the prefabricated part at nodes such as designing, production, transportation, construction, operation, maintenance and supervision.

The storing and screening unit 202 is configured to store quality-event business information of the nodes in business systems of the nodes, screen critical quality tracing information, and keep the critical quality tracing information into a blockchain distributed ledger.

The unifiedly inquiring and tracing module 1 according to the present embodiment integrates the relevant international norms for quality tracing, and the current standards in China of classification of prefabricated construction parts and so on, to form an unifiedly encoding regulation of prefabricated parts that is open-ended, extendable, suitable for the situation of a country and compatible with the international norms, thereby solving the problem of the most fundamental standard of quality tracing, whereby the quality tracing information of the prefabricated parts of the parties can be intercommunicated.

The present embodiment identifies unifiedly the prefabricated parts by using an Internet-of-Things RFID/barcode technique, identifies unifiedly RFID/barcode gathering devices and related operators; encodes and describes unifiedly quality events of the prefabricated parts at the nodes; and defines intra-blockchain and inter-blockchain tracing interfaces and access policy of the quality events.

The tracing-information Internet-of-Things gathering module 2 according to the present embodiment, by using authenticated fixed/hand-held reading devices, efficiently and safely gathers and records the tracing of the quality information at the critical nodes such as designing, production, transportation, construction, operation and maintenance, stores relevant business data in the business systems, and uploads merely the quality information of the quality events of the critical nodes and the tracing-interface information to the blockchain, to realize light weighting of chain uploading of the quality tracing information.

In the present embodiment, the tracing-information blockchain bookkeeping module 3 saves the quality tracing information of the nodes in the blockchain system, and the type of the blockchain is between public blockchain and private blockchain, which can effectively improve the consensus efficiency and the expansibility of the nodes. Moreover, the blockchain system performs classification and feature extraction to the quality tracing data of the authorized enterprises and the authorized reading devices every day based on the multilayer convolutional neural network, to perform action judgement and authorization controlling.

The unifiedly inquiring and tracing module 4 according to the present embodiment, by using intra-blockchain and inter-blockchain tracing interfaces of the quality events at the nodes, further accesses the particular information of the quality events stored in the business systems of the nodes; and, based on the safe access policy, feeds back open information and private information to inquiring parties according to the permission settings.

The first embodiment of the present disclosure can effectively solve the problems in the standard, efficiency, reliance, safety and supervision of the quality tracing in the industrialization of constructions, and can support the tracing of quality-event information of prefabricated parts in full supply chain, all over the world and during full life cycle.

The particular details of the operations of the above modules can be seen in the above description on the method according to the present disclosure with reference to FIG. 1, and are not discussed here in further detail.

### The Second Embodiment

In order to solve the problem in the prior art that, in the field of constructions, the full-chain tracing in the process of constructing and the full-life-cycle tracing in the process of construction, operation and maintenance of the quality information of prefabricated parts cannot be realized in multiple dimensions, the second embodiment of the present disclosure provides a method and system for tracing a full-life-cycle quality of a prefabricated part.

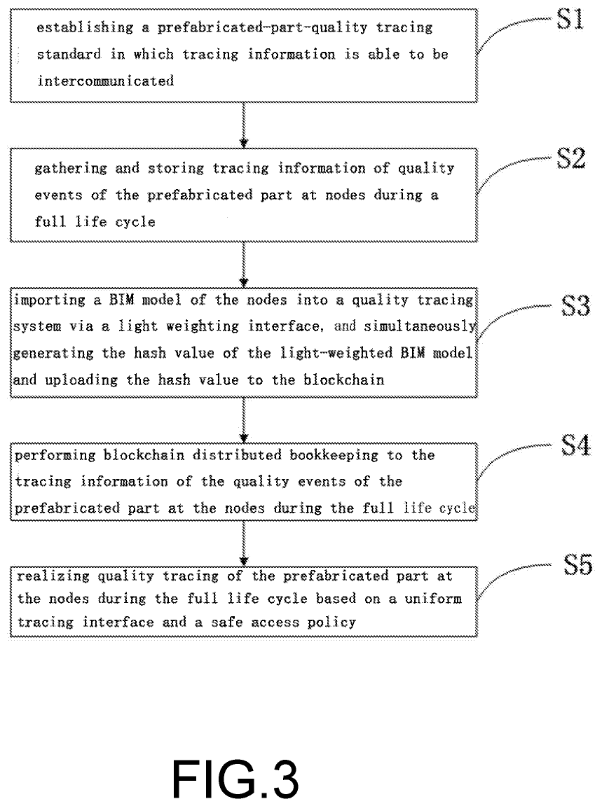

As shown in FIG. 3, FIG. 3 is a flow chart of the second embodiment of the present disclosure. The method according to the second embodiment of the present disclosure comprises the steps of:

step S1: encoding unifiedly prefabricated parts; identifying unifiedly the prefabricated parts by using an Internet-of-Things RFID/barcode technique, and identifying unifiedly RFID/barcode gathering devices and related operators; encoding and describing unifiedly quality events of the prefabricated parts at the nodes; and defining intra-blockchain and inter-blockchain tracing interfaces and access policy of the quality events.

The step S2 comprises: by using authenticated fixed/hand-held reading devices, efficiently and safely gathering and recording the tracing of the quality information at the critical nodes such as designing, production, transportation, construction, operation, maintenance and supervision, storing relevant business data in the business systems, and uploading merely the quality information of the quality events of the critical nodes and the tracing-interface information to the blockchain, to realize light weighting of chain uploading of the quality tracing information.

The step S3 comprises: importing a BIM model of the nodes into a quality tracing system via a light weighting interface, and simultaneously generating the hash value of the light-weighted BIM model and uploading the hash value to the blockchain.

The step S4 comprises: performing, by using the blockchain bookkeeping module 3, distributed bookkeeping of the quality-event business information of the critical nodes such as designing, production, transportation, construction, operation, maintenance and supervision, to realize the decentralization, undeletableness and unchangeableness of the storage of the quality-event tracing information of the critical nodes, wherein the blockchain bookkeeping module 3 is loosely coupled to the business systems.

The step S5 comprises: by using the tracing interfaces of the quality events at the nodes, further accessing the particular information of the quality events stored in the business systems of the nodes, and, based on the safe access policy, feeding back open information and private information to inquiring parties according to the permission settings.

The process of the operation of the method for tracing a full-life-cycle quality of a prefabricated part based on a blockchain according to the second embodiment of the present disclosure is as follows. The unified-tracing-standard module 10 is the basis of the standardized application of the entire method. The tracing-information Internet-of-Things gathering module 20 provides efficient and safe acquirement of the critical tracing information of the quality events at the nodes of the prefabricated part. The quality tracing BIM module 30 provides the application based on the spatial information of the construction and the logical relation between the systems (constructive/structural/mechanical and electric) of the construction. The tracing-information blockchain bookkeeping module 40 performs blockchain distributed bookkeeping of the quality events of the critical nodes such as designing, production, transportation, construction, operation, maintenance and supervision. Finally, the unifiedly inquiring and tracing module 50 realizes unified inquiring and tracing of the quality information based on a uniform tracing interface and a safe access policy.

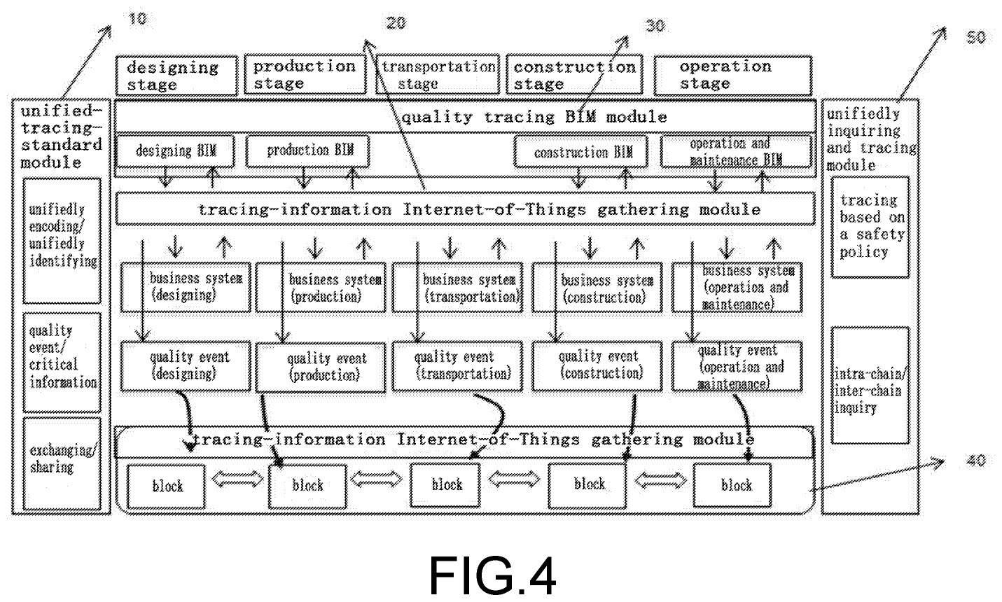

As shown in FIG. 4, FIG. 4 is a system diagram of the second embodiment of the present disclosure. The system for tracing a full-life-cycle quality of a prefabricated part based on a blockchain according to the second embodiment of the present disclosure comprises:

a unified-tracing-standard module 10 configured to, by using a prefabricated-part encoding rule, a quality-event encoding rule and a quality-tracing-interface rule that are built in the system, establish the prefabricated-part-quality tracing standard;

a tracing-information Internet-of-Things gathering module 20 configured to efficiently and safely gather the tracing information of the quality events at the nodes of the prefabricated part;

a quality tracing BIM module 30 configured to import a BIM model of the nodes into the quality tracing system via a light weighting interface, which can realize the association of the prefabricated part with the designing information, the spatial position information of the construction and the logical relation between the systems of the construction;

a tracing-information blockchain bookkeeping module 40 configured to perform distributed bookkeeping of the tracing information of the quality events at the nodes of the prefabricated part; and

a unifiedly inquiring and tracing module 50 configured to realize the quality tracing of the prefabricated part during the full life cycle based on a uniform tracing interface and a safe access policy.

In conclusion, the method and system according to the second embodiment of the present disclosure can effectively solve the problems in the standard, efficiency, reliance, safety and supervision of the quality tracing in the industrialization of novel constructions, support the quality tracing of prefabricated parts in full supply chain, all over the world and during full life cycle, improve the transparency and the management quality of the entire supply chain, and improve the level of management during full life cycle of constructions. Moreover, they help the construction industry of China enter the global market, to practice the “One Belt and One Road” strategy of the country.

The particular details of the operations of the above modules can be seen in the above description on the method according to the present disclosure with reference to FIG. 3, and are not discussed here in further detail.

It can be seen that the present disclosure can effectively solve the problems in the standard, efficiency, reliance, safety and supervision of the quality tracing in the industrialization of constructions. Furthermore, the present disclosure can support the tracing of quality-event information of prefabricated parts in full supply chain, all over the world and during full life cycle.

Particularly, the second embodiment of the present disclosure can realize efficient and safe gathering and recording of the tracing information of the quality events at the nodes such as designing, production, transportation, construction, operation, maintenance and supervision.

Particularly, the second embodiment of the present disclosure can realize the association of prefabricated parts with the spatial position relation and the logical relation between the systems.

Particularly, the second embodiment of the present disclosure can realize the blockchain distributed bookkeeping of the tracing information of the quality events at the nodes such as designing, production, transportation, construction, operation, maintenance and supervision, to realize the decentralization, undeletableness and unchangeableness of the storage of the quality-event tracing information.

Particularly, the second embodiment of the present disclosure can, by using the unifiedly inquiring and tracing module, by using the quality-event distributed ledger, realize inquiring and quality tracing based on the safe access policy.

Particularly, the second embodiment of the present disclosure can realize the association and tracing of prefabricated parts with the quality-event information in the process of construction, operation and maintenance and the process of constructing (designing, production, transportation and construction).

A person skilled in the art should understand that the above-described modules and steps according to the present disclosure may be implemented by using generic computing devices, and they may be concentrated on a single computing device, or be distributed in a network comprising multiple computing devices. Optionally, they may be implemented by using a computer executable program code. Therefore, they may be stored in a storage device and executed by a computing device, or be individually implemented into individual integrated-circuit modules, or some modules or steps among them may be implemented into a single integrated-circuit module. Accordingly, the present disclosure is not limited to any particular combination of hardware and software.

Although the embodiments disclosed by the present disclosure are described above, the descriptions are merely embodiments that are used for facilitating the understanding of the present disclosure, and are not intended to limit the present disclosure. A person skilled in the art can make any modifications and variations with respect to the forms and details of the implementation without departing from the spirit and scope of the present disclosure. However, the protection scope of the present disclosure should be subject to the scope defined by the appended claims.

What is claimed is:

1. A method for tracing a full-life-cycle quality of a prefabricated part based on a blockchain, wherein the method comprises the steps of:
step S1: establishing a prefabricated-part-quality tracing standard in which tracing information is able to be intercommunicated;
step S2: gathering and storing tracing information of quality events of the prefabricated part at nodes during a full life cycle;
step S3: performing blockchain distributed bookkeeping to the tracing information of the quality events of the prefabricated part at the nodes during the full life cycle; and
step S4: realizing quality tracing of the prefabricated part at the nodes during the full life cycle based on a uniform tracing interface and a safe access policy.

2. The method for tracing a full-life-cycle quality of a prefabricated part based on a blockchain according to claim 1, wherein the nodes of the prefabricated part during the full life cycle include one or more nodes selected from designing, production, transportation, construction, operation, maintenance and supervision.

3. The method for tracing a full-life-cycle quality of a prefabricated part based on a blockchain according to claim 1, wherein the step S1 comprises:
encoding unifiedly prefabricated parts;
identifying unifiedly the prefabricated parts by using RFIDs or barcodes;
identifying unifiedly RFID/barcode gathering devices and related operators;
encoding and describing unifiedly quality events of the prefabricated parts at the nodes; and
defining tracing interfaces and access protocols of the quality events of the prefabricated parts at the nodes.

4. The method for tracing a full-life-cycle quality of a prefabricated part based on a blockchain according to claim 1, wherein the step S2 comprises:
gathering by using a gathering unit the tracing information of the quality events of the prefabricated part at the nodes during the full life cycle; and
by using a storing and screening unit, storing quality-event business information of the nodes in business systems of the nodes, screening critical quality tracing information, and keeping the critical quality tracing information into a blockchain distributed ledger, to realize light weighting of chain uploading of the quality tracing information.

5. The method for tracing a full-life-cycle quality of a prefabricated part based on a blockchain according to claim 4, wherein the quality tracing method further comprises: before the step S3, importing a BIM model of the prefabricated part at the nodes during the full life cycle into a quality tracing system, and simultaneously uploading a generated hash value of the BIM model to the blockchain distributed ledger.

6. The method for tracing a full-life-cycle quality of a prefabricated part based on a blockchain according to claim 5, wherein the step S3 comprises:
step S301: establishing and initializing a blockchain, authorizing read-write access permission to the blockchain, analyzing operation data and operation characteristics of an authorized party, and if an abnormal behavior happens, revoking the permission;
step S302: keeping an ID, critical tracing information, a digital signature and a timestamp of the quality event into the blockchain distributed ledger; and
step S303: performing, by a supervising party, casual inspection to the quality event to obtain supervision-result information, and keeping the ID, the supervision-result information, the digital signature and the timestamp of the quality event into the blockchain;
wherein the blockchain comprises one source-blockchain address and a plurality of destination-blockchain addresses, and the quality event is transmitted from the source-blockchain address to the destination-blockchain addresses via a proprietary network.

7. The method for tracing a full-life-cycle quality of a prefabricated part based on a blockchain according to claim 6, wherein the step S4 comprises:
by using the uniform tracing interface of the quality events of the nodes, further accessing particular information of the quality events; and
based on the safe access policy, feeding back open information and private information to inquiring parties having different permissions according to different permission settings.

8. A system for tracing a full-life-cycle quality of a prefabricated part based on a blockchain, wherein the system comprises:
a unified-tracing-standard module configured to establish a prefabricated-part-quality tracing standard in which tracing information is able to be intercommunicated;
a tracing-information Internet-of-Things gathering module configured to gather and store tracing information of quality events of the prefabricated part at nodes during a full life cycle;
a tracing-information blockchain bookkeeping module configured to perform blockchain distributed bookkeeping to the tracing information of the quality events of the prefabricated part at the nodes during the full life cycle; and
a unifiedly inquiring and tracing module configured to realize quality tracing of the prefabricated part at the nodes during the full life cycle based on a uniform tracing interface and a safe access policy.

9. The system for tracing a full-life-cycle quality of a prefabricated part based on a blockchain according to claim 8, wherein the quality tracing system further comprises:
a quality tracing BIM module configured to import a BIM model of the prefabricated part at the nodes during the full life cycle into the quality tracing system, and simultaneously upload a generated hash value of the BIM model to the blockchain distributed ledger.

10. The system for tracing a full-life-cycle quality of a prefabricated part based on a blockchain according to claim 8, wherein the tracing-information blockchain bookkeeping module is further configured to, based on a multilayer convolutional neural network, perform classification, characteristic extraction, action judgement and authorization controlling to the quality-event tracing information.
